(19) United States
(12) Patent Application Publication
(10) Pub. No.: US 2013/0212011 A1
(43) Pub. Date: Aug. 15, 2013

(54) Closed Loop Accounts Payable Network System and Method

(71) Applicants: Allen Cage, Chantilly, VA (US); Steve Carlson, Manassas, VA (US); Kevin Woods, Manassas, VA (US); Todd King, Columbus, GA (US)

(72) Inventors: Allen Cage, Chantilly, VA (US); Steve Carlson, Manassas, VA (US); Kevin Woods, Manassas, VA (US); Todd King, Columbus, GA (US)

(21) Appl. No.: 13/767,423

(22) Filed: Feb. 14, 2013

Related U.S. Application Data
(60) Provisional application No. 61/598,890, filed on Feb. 14, 2012.

(51) Int. Cl. G06Q 20/14

(52) U.S. Cl. CPC G06Q 20/14
USPC 705/40

(57) ABSTRACT

A system and method operable to provide a closed loop accounts payable network with end-user rate-adjustment options. The system and method for a closed loop accounts payable network for commercial card payments allows for setting one or more payment terms using the system.

### CROSS-REFERENCE TO RELATED APPLICATION

This Patent Application claims priority to U.S. Patent Application Ser. No. 61/598,890 filed Feb. 14, 2012 and titled Methods and Systems for a Closed Loop Accounts Payable Network, the entire contents of which is incorporated herein by reference in its entirety.

### BACKGROUND

1. Field

The present inventive concept pertains to a system for an accounts payable network and a method of using the system. The present inventive concept more particularly concerns a system for a closed loop accounts payable network for commercial card payments and a method of setting one or more payment terms using the system.

2. Discussion of Related Art

Successful buyer and seller (or supplier) transactions are concluded to the satisfaction of both parties. It has become more difficult, however, to convince buyers to conclude transactions using card association based products, such as cards provided under the trademarks VISA® and MASTERCARD®, as a form of payment in business-to-business transactions. This problem is due to high costs associated with such, for example interchange rates. The costs charged by associations and other key stakeholders are highly inflexible, particularly as related to traditional business-to-business (B2B) transactions, and often a primary reason suppliers refuse to accept them as a form of payment. As used herein, a buyer can include, by way of example and not limitation, a buying organization, an individual, a corporate entity, a public or private sector organization, or any other entity that buys supplies and/or services from a seller or supplier. A seller can include, without limitation, a supplier of goods or services, a merchant, a vendor, or any other entity that provides goods, suppliers, and/or services to a buyer.

By refusing to accept card association based products, parties forego a number of benefits, which may cause or fail to prevent other problems. For instance, card-based payments offer enhanced control of transactions, offer enriched data with respect to information related to transactions, and enable automated reconciliation of errors and payments.

Nevertheless, supplier use of accounts payable payment solutions provided by various entities, including card associations, financial issuers, and third party technology companies have decreased in certain areas and have not increased as expected in others, and are predicted to continue to decrease until lower cost solutions are offered for B2B transactions.

Thus, there is a need for a system and method for an accounts payable network that does not suffer from the aforementioned problems and provides suppliers with enhanced control of transactions, offers enriched data with respect to information related to transactions, and enables automated reconciliation of errors and payments.

### SUMMARY

The present inventive concept described herein remedies the aforementioned problems by providing a unique system and method for a closed loop accounts payable network operable to permit, among other things, rate-adjustment of fees related to use of the network by users, such as end users, of the network.

The system and method of the present inventive concept provide a closed loop payment network that permits negotiation of rates paid by one or both users or parties to a transaction, for example, a seller or supplier and a purchaser or organization. In this manner, a rate to use or accept a card based payment may be negotiated between the parties, for example, a financial institution (where a financial institution includes, by way of example and not limitation, any type of entity that funds the payment to the supplier and takes on the risks associated with funding), the supplier, and/or the organization instead of being unilaterally specified by a provider of the card used in the transaction.

The system and method of the present inventive concept provide buyers with a higher potential of merchant acceptance of electronic payments, ability to capture additional revenue share for previously unavailable transaction volume, and 100% reconciliation in client buyer (and seller) GL/ERP systems, that is, payment amount will always match amount due on invoices. Because nothing manual is done by the supplier via the present inventive concept, i.e., purchase amount keyed into POS, no transactions can be run for any other amount then what is due based on invoice amount. Thus, 100% reconciliation is provided via the present inventive concept. The system and method of the present inventive concept provide suppliers with negotiated reduced fees to process payments. The system and method of the present inventive concept provide buyers and sellers with an ability to dynamically agree to terms that, among other things, satisfy business cash flow needs.

The system and method of the present inventive concept provide financial institutions with increased spend volume converted to electronic payments, a non-traditional revenue stream, and an ability to negotiate unique rates with suppliers, clients, and the like, that is, revenue share, based on payment types. The system and method of the present inventive concept provide a commercial payments platform that is robust and provides a turnkey accounts payable solution operable to control all aspects of the processing of such payments. The system and method of the present inventive concept provide a closed loop processor system having increased efficiency, and is capable of processing a higher volume of transactions, for example, additional volume may be converted from checks. The system and method of the present inventive concept provide management of transactions via a central resource, and provide a supplier with an option of dynamically electing to change or accept a rate to-be paid based on when the supplier wants to be paid upon approval of a submitted invoice to a buyer. The system and method of the present inventive concept can provide a significant increase in merchant or supplier acceptance relative to acceptance rates currently received by such due to reduced fees, that is, a discounted rate/interchange provided to the merchant via the present inventive concept.

The system and method of the present inventive concept allow entities the ability to offer accounts payable based payment solutions to specific verticals or industries such as healthcare or pharmaceuticals. Such industries are currently dominated by other payment methods, such as checks, ACH, and the like. Thus, the lower rates provided by the system and method of the present inventive concept facilitates new incremental business-to-business payment transactions for financial institutions. The system and method of the present inventive concept removes potential of supplier fraud from all transactions due to enhanced controls afforded to the buyer and sellers.

A service provider may incorporate a new payment option, for example, the closed loop payment system of the present inventive concept in a preexisting system, e.g., ePayables platform, as another payment option. This payment option can, for example, be enabled at the level of a financial institution and then subsequently at the level of a buyer. In particular, the commercial payments platform can be configured to control entities that are authorized to use the system, which can be driven by configurable options.

Parties of the system of the present inventive concept may have the ability to dynamically define the payment transaction rate, that is, amount a supplier must pay for each payment. Controls available to the financial institution by the system of the present inventive concept may include an ability to govern rates or change one or more rates. Control provided to an organization by the system of the present inventive concept may include rates or rate ranges inherited from control by the financial institution when new merchants enroll in or otherwise accept the form of payment provided by the present inventive concept.

The system of the present inventive concept may allow an organization to provide an incentive or reward to a supplier for successful transactions via the organization offering better rates to the supplier, for instance, rates within one or more rate thresholds set by an issuer of a card used in the transactions. As an example, a health care facility that buys from large healthcare suppliers may offer better rates to these large suppliers for large dollar transactions (e.g., purchase of a $500,000 MRI machine) versus a seller who does not process large dollar amounts on behalf of the buying healthcare organization. Also, a healthcare organization may be able to offer different rates based upon the type of supplies or services being procured from a healthcare supplier versus a single rate for an entire invoice or purchase order. As another example, in the IT industry, a supplier may accept a small ticket item (e.g., a $4000 computer) but not a high ticket item (e.g., greater than $100,000).

The system of the present inventive concept may be configured to accept invoice files from an organization and dynamically identify which invoices need to be paid via the system and identify a rate to charge for processing each transaction.

Files may be processed via file or web based push/pull from an organization through the system of the present inventive concept. The system of the present inventive concept may initiate/capture authorization(s) on closed loop account information assigned to an organization.

A buyer and/or supplier may receive an alert or notification when a purchase has been authorized to provide management of funds via an ERP/accounts payable system. The system of the present inventive concept may initiate closed loop transactions, for example, approved authorizations, and route them to a closed loop processor.

Based on settings within the commercial payments platform of a service provider, the supplier may access a web based version of a supplier portal and, when authorized and set up by an organization, request different payment terms based on when they want to be paid. This can be used to dynamically change terms of a payment to a seller and then submit the payment with the newly defined payment terms through the system of the present inventive concept.

Dynamic control of payment terms may include an option to request immediate payment or cash on demand, for example, payment due between 24 and 48 hours of setting the option, or through a dynamic interface, change and/or observe any payment term changes. Likewise, the organization may select what payment terms are most ideal based on a transaction so that different transactions may be subject to different payment terms.

Enrollment of a supplier may be completed on the system of the present inventive concept and through integration to a processing platform, the supplier may be linked to its information to ensure payments can be pushed to the supplier and fees can be pulled from other suppliers. The supplier enrollment may have alternatives such as, but not limited to, self-enrollment capabilities so that third parties may enroll new suppliers to the system of the present inventive concept. This may be a resource within the system of the present inventive concept, available to one or more financial institutions, and/or a system can be set up to send potential suppliers directly to a supplier portal for self enrollment.

An organization may manage completed payments such as, but not limited to within the ePayables platform, via the system of the present inventive concept. The organization may receive automated file or web service calls to automatically update their ERP/AP platform when a payment has been processed via the system of the present inventive concept. The organization may be notified of a sent payment at or near real-time via the system of the present inventive concept. The organization may have one or more options to facilitate management of day to day cash flow via the system of the present inventive concept, for example, payment when the organization requests such or adhering to standard payment terms.

A supplier may manage payments on a supplier portal and view pending payments and historical payments via the system of the present inventive concept. The supplier may maintain and store records regarding their receivables via the system of the present inventive concept, thereby providing cash flow management, budgeting, and ordering.

The aforementioned may be achieved in an aspect of the present inventive concept by providing a method, implemented at least in part by a computing device, operable to enable buyer-supplier managed and initiated electronic transactions for goods or services over a closed loop payment network. The method may include the steps of enrolling a supplier in a commercial payments platform, transmitting a request for the goods or services to the supplier, the request transmitted to the supplier by a buyer, generating an invoice for the goods or services to the buyer, and/or notifying the supplier of a pending payment. The method may further include the steps of applying a dynamic rate change to the pending payment, the dynamic rate change initiated by the supplier, transmitting payment information for processing to a processing platform, transmitting merchant funding information to a financial institution, and/or processing a payment to a bank account of the supplier, the payment processed by a financial institution. The method may further include the step of revising the invoice based on criteria established at least in part by the supplier, the invoice revised by the supplier.

The criteria may be a transaction fee generated at least in part by a third party to process payment for the goods or services. The commercial payments platform may include a network-based electronic system operable to deliver the payment to the supplier. The commercial payments platform may be configured to deliver the payment to the supplier via at least one of a credit card, a traditional commercial payment network, a proprietary closed loop network, a check, or an ACH payment.

The aforementioned may be achieved in another aspect of the present inventive concept by providing a system operable to process an electronic transaction between a buyer and seller over a closed loop payment network. The system may include a commercial payments platform having a network-based electronic system operable to (i) invoice and collect funds from a buyer of goods or services, and/or (ii) deliver the funds to a supplier of the goods or services. The system may further include a supplier platform having a payment portal operable to (i) provide access to an invoice from the supplier awaiting payment from the buyer, (ii) permit modification to a payment term, and/or (iii) upload the invoice electronically for approval and processing by the buyer.

The system may be implemented at least in part by a computing device. The payment term may be at least one of a payment amount and a payment deadline. The payment amount may be a transaction fee generated at least in part by a third party to deliver the funds for the goods or services.

The aforementioned may be achieved in another aspect of the present inventive concept by providing a commercial payments system operable to enable an electronic transaction between a buyer and a seller over a closed loop payment network. The commercial payments system may include a network-based electronic system operable to collect funds from the buyer and transfer the funds to the supplier. The network-based electronic system may be operable to enroll the supplier via collection of data associated with the supplier, notify the supplier of a new invoice, allow the supplier to revise a payment term associated with the invoice, post transaction and merchant settlement information, and/or transmit payment remittances to the supplier. The commercial payments system may be implemented at least in part by a computing device.

The aforementioned may be achieved in another aspect of the present inventive concept by providing a method to allow a supplier of goods or services to dynamically adjust a transaction fee for processing an invoice. The method may include the steps of receiving notification of a pending payment via a commercial payment portal, revising a payment term of the invoice, the revision initiated by the supplier of the goods or services, and/or submitting the revised invoice to the commercial payment portal for payment by a purchaser of the goods or services. The commercial payment portal may be implemented at least in part by a computing device. The payment term may be at least one of a payment amount and a payment deadline. The payment amount may be a transaction fee generated at least in part by a third party to deliver the funds.

Additional objectives, aspects, advantages, and utilities of the present inventive concept will be set forth in part in the description which follows and, in part, will be obvious from the description, or may be learned by practice of the present inventive concept.

The foregoing is intended to be illustrative and is not meant in a limiting sense. Many features and subcombinations of the present inventive concept may be made and will be readily evident upon a study of the following specification and accompanying drawings comprising a part thereof. These features and subcombinations may be employed without reference to other features and subcombinations.

### BRIEF DESCRIPTION OF THE DRAWINGS

The present inventive concept is described in detail below with reference to the attached drawing figures, wherein:

FIG. 1 is a diagram illustrating an example of a process of the present inventive concept.

The drawing figures do not limit the present inventive concept to the specific examples disclosed and described herein. The drawings are not necessarily to scale, emphasis instead being placed upon clearly illustrating the principles of the present inventive concept.

### DETAILED DESCRIPTION

The following detailed description references the accompanying drawings that illustrate the present inventive concept. The illustrations and description are intended to describe aspects of the present inventive concept in sufficient detail to enable those skilled in the art to practice the present inventive concept. Other components can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to ‘one embodiment,” “an embodiment,” or “embodiments” mean that the feature or features being referred to are included in at least one embodiment of the present inventive concept. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present inventive concept can include a variety of combinations and/or integrations of the embodiments described herein.

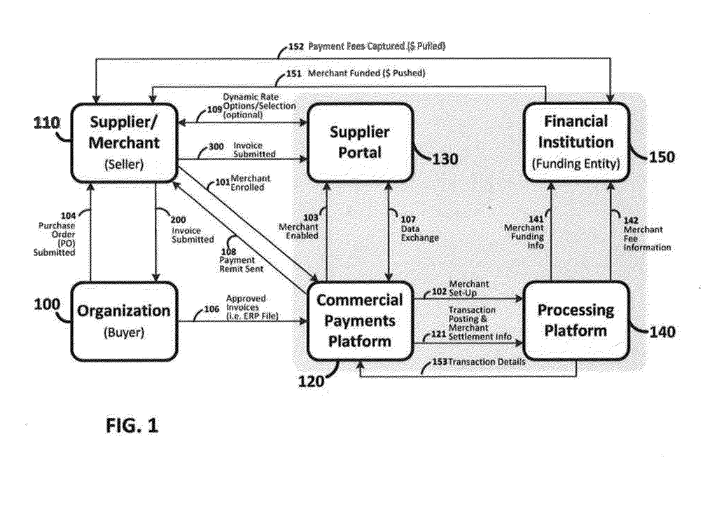

Turning to FIG. 1, organization 100 is a buyer of goods, services, and/or the like. The origanization 100 may be a public or private entity such as a state governmental agency, a federal governmental agency, a corporation, or a business. The origanization 100 may employ one or more computing devices to carry out at least some of the functionality described herein with respect to the system and method of the present inventive concept. The computing device, as referenced in connection with the present inventive concept, may be a personal computer (PC) system, a server, a portable computer, such as a notebook computer, or any data processing system, a personal digital assistant (PDA), a communication device such as a cell phone, or device that is capable of being connected to a network of one or more computers.

Supplier 110 is a seller of of goods, services, and/or the like, and may be a merchant, seller, vendor, supplier and/or the like. The supplier 110 may be a provider of goods and/or services to the organization 100. Similar to the origanization 100, the supplier 110 may also employ one or more computing devices to carry out at least some of the functionality described herein with respect to the system and method of the present inventive concept.

A commercial payments platform 12, generally referenced herein as the system of the present inventive concept, is a web based electronic commercial payment platform configured to operate at least partly on one or more computing devices. The commercial payments platform 12 is capable of paying the supplier 110 in a variety of ways including, but not limited to, via a credit card, a proprietary network account, a check or an ACH on behalf of the organization 100.

A supplier portal 130 is a gateway configured to provide the supplier 110 with access to invoices submitted by and awaiting payment by the organization 100. In a prefered embodiment of the present invention, the supplier 110 must be enrolled in the commercial payments platform 12 to access their invoices. If granted permission during such enrollment, for example, via the commercial payments platform 12, the supplier 110 is able to submit changes to their invoices to, for example, change a payment term and/or a payment date. A supplier portal 130, also defined as a warehouse, is configured to allow the supplier 110 to upload invoices electronically for approval and processing by the organization 100 and/or the commercial payments platform 130 in an automated or manual fashion depending upon business rules or settings defined by the organization 100. The supplier portal 130 can employ one or more computing devices to carry out at least some of the functionality described herein with respect to the system and method of the present inventive concept.

A processing platform 140 is configured to receive a request for authorization from the commercial payments platform 120. The processing platform 140 is configured to process a payment to the supplier 110 via their payment rails (i.e., their proprietary network and payment protocols). Additionally, processing platform 140 is configured to withdraw funding from a financial institution 150 and convey the funding to the supplier 110.

The financial institution 150 is the funding entity and can include commercial financial issuers or investment entities who offer commercial payment capabilities to the organization 100, for example, on credit terms or via transaction based payments. The financial institution 150 can utilize one or more computing devices to carry out at least some of the functionality described herein with respect to the system and method of the present inventive concept.

In use, the origanization 100 provides a list of one or more of the suppliers 110 to the commercial payments platform 120 and/or the financial institution 150. The list of the suppliers 110 may include one or more of a merchant, a vendor, a supplier, and the like, and can be the entity that provides the supplies and or services agreed upon between the organization 100 and the supplier 110. This list of suppliers can be added to the commercial payments platform 120 in step 101. In step 102, the supplier information can also be added as a part of a merchant setup event to the processing platform 140.

The supplier 110 can be enrolled via the commercial payments platform 120 and set up via the processing platform 140. To do so, once the supplier 110 is set up within the commercial payments platform 120, the commercial payments platform 120 is configured to electroncially set up the supplier 110 on the processing platform 140 by gathering and sending information collected by the commercial payments platform 120 to the processing platform 140. In the exemplary embodiment, the processing platform 140 must be set up with information on the supplier 110 to fund the supplier 110 appropriately.

Information about the supplier 110 can be transmitted via the commercial payments platform 120 to the supplier portal 130 in step 103, which causes the supplier 110 to be enabled. For purposes herein, to be enabled, the supplier 110 must be set up within the commercial payments platform 120, the processing platform 140, and the supplier portal 130, at which point the suppler 110 can receive payments through the system.

The organization 100 can enter into a written or oral agreement or contract to procure goods and or services from the supplier 110. In this manner, goods and/or services may be conveyed therefrom. Goods can include any physical, electronic, or other type of deliverable that can be conveyed from the supplier 110 to the organization 100. Services can include any kind of activity that the supplier 110 can perform for the organization 100.

In step 104, the organization 100 creates a request, for example, a purchase order, and transmits such via any appropriate means, for example, electronically, telephonically, etc., to the supplier 110 to request supplies and/or services.

In step 200, the supplier 110 initiates shipment or delivery of the supplies and/or services requested by the organization 100, and then submits an invoice to the organization 100 via any appropriate delivery option such as mail, email, electronic or other forms of delivery. The invoice requests payment for the goods and/or services provided to the organization 100. Alternatively, in step 300, the supplier 110 has the ability to upload via a variety of electronic options the invoice for the organization 100 for the supplies and/or services that are supplied directly to the supplier portal 130. The supplier 110 may be required to manually enter one or more key pieces of data used to track the invoice through the system and allow for review of the invoice by the organization 100.

Upon receipt of an invoice from the supplier 110, the organization 100 electronically transmits, via a variety of transmission options such as file, web service, or the like, the invoice information in step 106 to commercial payments platform 120. If the supplier 110 elects to utlize the electronic invoice submission tools central to the supplier portal 130, the organization 100 can review these invoices in the commercial payments platform 120. When the supplier 110 uploads their invoices to the supplier portal 130 at step 300, the invoice data is sent to the commercial payments platform 120 from the supplier portal 130 at step 107. The organziation 100 is notified electronically by the commercial payments platform 120 that an invoice has been received for review that is outside of predetermined automated approval criteria and business rules set up by the organization 100 within the commercial payments platform 120. If the invoice is within the approval criteria and business rules set up by the organization 100, then the invoice is automatically approved, a log is created, and the invoice is processed for payment by the commercial payments platform 120.

For invoices that are not submitted via the supplier portal 130 by the supplier 110, once the invoice is received from the organization 100, in Step 106, the commercial payment platform 120 is configured to analyze the invoice request, e.g., file, web service, etc. and make any changes to the payment request based on approval criteria and business rules set up by the organization 100 and/or any specific rules defined and setup for the supplier 110 that originated the invoice. Upon completion, the commercial payment portal 120 is configured to update the supplier portal 130 with the payment information as seen in the data exchange in step 107.

Once the supplier portal 130 is updated by either the supplier 110 or the organziation 100, the supplier 110 is electronically notified of any pending payments, as seen in step 108, at which point a remittance is sent to the supplier 110. Alternatively, the supplier 110 can enter the supplier portal 130 and affect dynamic rate changes to the pending invoice payment, as shown in step 109. If the supplier 110 does not elect to make changes within a defined period of time annotated on the electronic notification sent to them from the supplier portal 130, then the transaction will process at a default rate set during the enrollment of the supplier 110 and the related enablement process,

It is foreseen that the commercial payments platform 120 may be configured to transmit pertinent payment information to the processing platform 140 for processing of the closed loop transaction on behalf of the organization 100 and/or the supplier 110 at step 121.

Upon receipt of the payment information for processing, the processing platform 140 electronically transmits merchant funding information to the financial institution 150 in step 141. This information can provide the financial institution 150 with information including, but not limited to, the supplier 110 name, direct deposit account, funding amount, and other information required to transmit funds to a bank account of the supplier 110.

The financial institution 150 can process a payment, for example, an ACH payment or wire, to the bank account of the supplier 110 for an amount of an invoice based on information provided by the supplier 110 in step 151. The system of the present inventive concept is operable to fund or transfer money to the account of the supplier 110 in 24 to 48 hours.

The processing platform 140 is configured to electronically transmit merchant fee information to the financial institution 150 in step 142. This information can provide the financial institution 150 information including, but not limited to, the supplier 110 name, direct deposit account for fee withdrawal, transaction fee amount, and/or other information required to withdraw or pull transaction fees from a bank account of the supplier 110 and transfer the transaction fees to a direct deposit account where the transaction fees are collectable.

The transaction fees are based on a rate negotiated between the supplier 110 and the financial institution 150 during the enrollment process at step 152. The transaction fees are paid by the supplier 110 to the financial institution 150 in exchange for the financial institution 150 accepting and processing electronic payments on behalf of the supplier 110. The financial institution 150 can pull the transaction fees during the enrollment process at step 152. The process of pulling payments includes collecting the transaction fees. It is foreseen that collection of the transaction fees can be performed via a third party network such as the National Automated Clearing House Association (NACHA) by creating an ACH file that can debit the fees from the account of the supplier 110 and deposit them in another DDA account where the fees are collectable.

It is foreseeable that electronic transaction data can be stored within the processing platform 140, for example, via a memory such as RAM or the like. The commercial payments platform 120 can receive a nightly data file from the processing platform 140 and data can be uploaded and made available within the commercial payments platform 120 for inquiry needs or for reporting needs.

After a payment has been made to the supplier 110, the electronic transaction data flows back through the processing platform 140 to the commercial payments platform 120, at step 153. The supplier portal 130 is automatically updated via a communication channel at step 107.

The organziation 100 and supplier 110 have access via their respective systems to review payments that have occurred, conduct reporting on such payments, and use data to reconcil their invoices.

In this manner, the present inventive concept provides a system and method configured to make payments using a closed loop electronic network that may push funds to an account, such as a DDA account, of the supplier 110 without the supplier 110 ever having to do anything. In other words, funds can be deposited without the supplier 110 being directly involved. Once the supplier 110 is enrolled in the system, all invoice payments are made directly to the DDA account of the supplier 110 via the network, such as, the NACHA network.

The system is operable to bypass any and all credit card associations via direct integration between the commercial payments platform 120 and the processing platform 140. Because the platorms 120, 140 are integrated via the present inventive concept, there is no need to use the card association networks to fund the merchant.

The commercial payments platform 120 allows rates/fees of the network to be defined by participating parties. Because associations are not involved, transactions using the system of the present inventive concept are not regulated by credit card associations. Thus, parties to the process can set rates, including, without limitation, the financial institution 150, the processing platform 140, and/or the organization 100. Additionally, the system of the present inventive concept allows the supplier 110 to have flexibility via negotiating a rate with the organization 100.

The previous description of the presently disclosed inventive concept is provided to enable any person skilled in the art to make or use the present inventive concept. Various modifications will be readily apparent to those skilled in the art, and the generic principles defined herein may be applied alternatively without departing from the spirit or scope of the present inventive concept. Thus, the present inventive concept is not intended to be limited to the description herein but is to be accorded the widest scope consistent with the principles and novel features disclosed herein.

The steps of a method, system, or operation described in connection with the present inventive concept disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Having now described the features, discoveries and principles of the present inventive aspect of this disclosure, the manner in which the present inventive aspect is constructed and used, the characteristics of the construction, and advantageous, new and useful results obtained: the new and useful structures, devices, elements, arrangements, parts and combinations, are set forth in the appended claims.

It is also to be understood that the following claims are intended to cover all of the generic and specific features of the present inventive aspect herein described, and all statements of the scope of the present inventive aspect which, as a matter of language, might be said to fall there between.

What is claimed is:

1. A method, implemented at least in part by a computing device, operable to enable buyer-supplier managed and initiated electronic transactions for goods or services over a closed loop payment network, the method comprising the steps of:
enrolling a supplier in a commercial payments platform;
transmitting a request for the goods or services to the supplier;
generating an invoice for the goods or services to the buyer;
notifying the supplier of a pending payment;
applying a dynamic rate change to the pending payment, the dynamic rate change initiated by the supplier;
transmitting payment information for processing to a processing platform;
transmitting merchant funding information to a financial institution; and
processing a payment to a bank account of the supplier, the payment processed by a financial institution.

2. The method of claim 1, wherein the transmitting step further comprises transmitting the request to the supplier by a buyer.

3. The method of claim 1, further comprising the step of:
revising the invoice based on criteria established at least in part by the supplier, the invoice revised by the supplier.

4. The method of claim 3, wherein the criteria being a transaction fee generated at least in part by a third party to process payment for the goods or services.

5. The method of claim 1, wherein the commercial payments platform includes a network-based electronic system operable to deliver the payment to the supplier.

6. The method of claim 5, wherein the commercial payments platform is configured to deliver the payment to the supplier via at least one of a credit card, a traditional commercial payment network, a proprietary closed loop network, a check, or an ACH payment.

7. A system operable to process an electronic transaction between a buyer and seller over a closed loop payment network, the system comprising:
a commercial payments platform having a network-based electronic system operable to (i) invoice and collect funds from a buyer of goods or services, and (ii) deliver the funds to a supplier of the goods or services; and
a supplier platform having a payment portal operable to (i) provide access to an invoice from the supplier awaiting payment from the buyer, (ii) permit modification to a payment term, and (iii) upload the invoice electronically for approval and processing by the buyer.

8. The system according to claim 7, wherein the system is implemented at least in part by a computing device.

9. The system according to claim 7, wherein the payment term is at least one of a payment amount and a payment deadline.

10. The system according to claim 9, wherein the payment amount is a transaction fee generated at least in part by a third party to deliver the funds for the goods or services.

11. A commercial payments system operable to enable an electronic transaction between a buyer and a seller over a closed loop payment network, the commercial payments system comprising:
a network-based electronic system operable to collect funds from the buyer and transfer the funds to the supplier,
wherein the network-based electronic system is operable to,
enroll the supplier via collection of data associated with the supplier,
notify the supplier of a new invoice,
allow the supplier to revise a payment term associated with the invoice,
post transaction and merchant settlement information, and
transmit payment remittances to the supplier.

12. The commercial payments system according to claim 11, wherein the commercial payments system is implemented at least in part by a computing device.

13. The commercial payments system according to claim 11, wherein the payment term is at least one of a payment amount and a payment deadline.

14. The commercial payments system according to claim 13, wherein the payment amount is a transaction fee generated at least in part by a third party to deliver the funds.

15. A method to enable a supplier of goods or services to dynamically adjust a transaction fee for processing an invoice, the method comprising the steps of:
receiving notification of a pending payment via a commercial payment portal;
revising a payment term of the invoice, the revision initiated by the supplier of the goods or services; and
submitting the revised invoice to the commercial payment portal for payment by a purchaser of the goods or services.

16. The method according to claim 15, wherein the commercial payment portal is implemented at least in part by a computing device.

17. The method according to claim 15, wherein the payment term is at least one of a payment amount and a payment deadline.

18. The method according to claim 17, wherein the payment amount is a transaction fee generated at least in part by a third party to deliver the funds.
